(19) United States
(12) Patent Application Publication
(10) Pub. No.: US 2009/0287523 A1
(43) Pub. Date: Nov. 19, 2009

(54) SHOWING AND CORRECTING IRREGULARITIES IN A SCHEDULE

(75) Inventors: Bonny Pui Kwan Lau, Bellevue, WA (US); Alice Pritikin Steinglass, Redmond, WA (US); Monica Estela Gonzalez Veron, Seattle, WA (US); Peter de Vries, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/123,449

(22) Filed: May 19, 2008

(51) Int. Cl. G06Q 10/00

(52) U.S. Cl. 705/8

(57) ABSTRACT

Technologies are described herein for showing and correcting irregularities in a schedule. A project management application allows a user to manually define tasks within a schedule. The application evaluates the manually defined tasks to determine if the tasks cause an irregularity within the schedule. If so, the application provides one or more visual indications of the irregularity to the user. The application also provides functionality for allowing a user to resolve or ignore the irregularity.

### BACKGROUND

Project management application programs provide significant functionality for assisting project managers in scheduling and monitoring large numbers of tasks. In this regard, many project management application programs provide functionality for automatically scheduling tasks. Using this functionality, for instance, a project manager can enter information for a task, such as the duration of the task, resource assignments, and dependencies upon other tasks. The project management application program will calculate start and finish dates for the task using the provided information, thereby greatly simplifying the project planning process.

While the built-in scheduling logic provided by most project management application programs is powerful, some users find application of the logic to be too automated. One reason for this is that the task start and finish dates are almost always calculated automatically. As a result, the automatically calculated dates may override the user-provided dates if there is a conflict with the automatically calculated dates. Consequently, users often struggle to define their schedule in the desired manner because the project management application continually adjusts the user-provided dates based upon algorithmic calculations.

One approach to solving this shortcoming is to allow users to completely manually schedule their projects. For instance, using manual scheduling a project manager can manually provide the start date, finish date, and duration for any task in a project. The project management application will accept any user-provided value, thereby providing the user with much greater flexibility and control over their data. With this virtually unlimited flexibility, however, comes the strong likelihood that a user will create a schedule that includes irregularities. For instance, a user may create an overly optimistic schedule that includes dates that realistically need to be delayed, tasks that include dates that need to be modified due to dependencies upon other tasks, or commit resources beyond their maximum capacity. Conversely, a user may not realize that some tasks may be started earlier to thereby optimize the schedule.

It is with respect to these considerations and others that the disclosure made herein is presented.

### SUMMARY

Technologies are described herein for showing and correcting irregularities in a schedule. In particular, through the embodiments presented herein, a project management application is provided that allows a user to manually define tasks within a schedule. The application evaluates the manually defined tasks to determine if the tasks cause an irregularity within the schedule. If so, the application provides one or more visual indications of the irregularity to the user and provides functionality for allowing a user to resolve the irregularity. In this manner, the project management application provides a user with the flexibility to manually define the tasks within a schedule and, at the same time, provides all of the benefits of automated task scheduling.

According to one aspect presented herein, a visual indication of an irregularity within a schedule caused by a manually defined task is provided by setting a visual attribute for indicating the irregularity on a visual element associated with the manually defined task. For instance, a visual element may be set on a date associated with the manually defined task, an identifier for a resource associated with the manually defined task, or a Gantt bar associated with a manually defined task to thereby indicate the irregularity. A Gantt bar is a visual element within a Gantt chart that is utilized to depict the duration of a task or utilization of a resource within a project schedule. A Gantt chart is a bar chart utilized to depict the tasks and resources within a project schedule. It should be appreciated that an icon or other type of graphical element may also be displayed to indicate that an irregularity is present in the schedule.

According to other aspects, the visual element may be selected using an appropriate user input device. In response to such a selection, options may be displayed for addressing the irregularity indicated by the visual element. If one of the options is selected, the selected option will be performed for addressing the irregularity. According to embodiments, one of the options provides functionality for automatically scheduling the manually defined task that includes the irregularity. In other embodiments, an option is displayed that provides functionality for removing the visual indication of the irregularity thereby allowing a user to ignore the irregularity.

According to other embodiments, one of the options includes functionality for displaying recommendations for correcting the irregularity. The displayed recommendations for correcting the irregularity may include a recommendation for modifying a date associated with the manually defined task and leaving the manually defined task in a manual scheduling mode, a recommendation for modifying a date associated with the manually defined task and changing the manually defined task to an automatic scheduling mode, and a recommendation for ignoring the irregularity in the schedule caused by the manually defined task by removing the visual indications.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer architecture diagram showing an illustrative computer hardware and software architecture for a computing system capable of implementing aspects of the embodiments presented herein;

FIGS. 2-5 are user interface diagrams showing various user interfaces provided in embodiments presented herein for showing and correcting irregularities in a schedule; and

FIGS. 6A-6B are flow diagrams showing one illustrative routine for showing and correcting irregularities in a schedule according to one embodiment presented herein.

### DETAILED DESCRIPTION

The following detailed description is directed to technologies for showing and correcting irregularities in a schedule. While the subject matter described herein is presented in the general context of an application program that operates in conjunction with the execution of an operating system on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for showing and correcting irregularities in a schedule will be described.

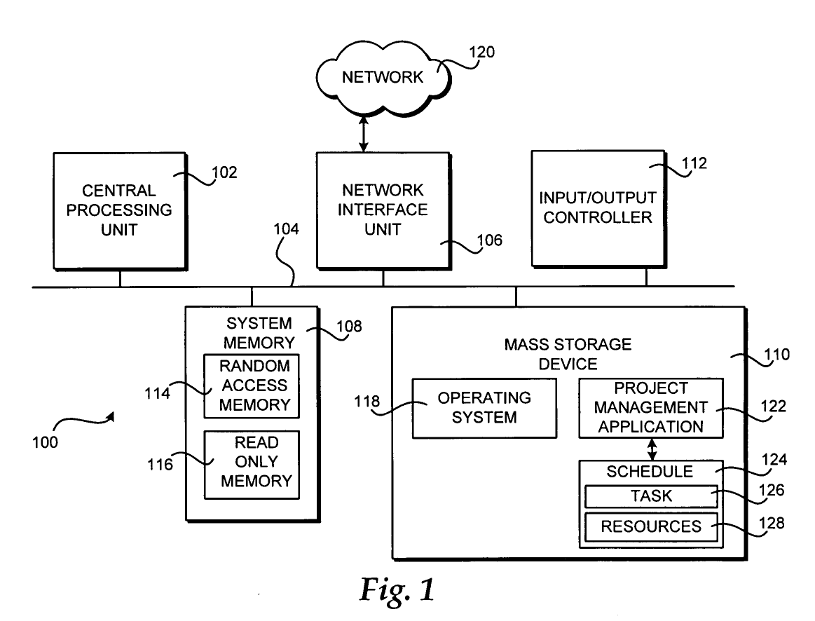

Turning now to FIG. 1, details will be provided regarding an illustrative operating environment and several software components provided by the embodiments presented herein. In particular, FIG. 1 shows an illustrative computer architecture for a computer 100 capable of executing the software components described herein for showing and correcting irregularities in a schedule. The computer architecture shown in FIG. 1 illustrates a conventional desktop, laptop, or server computer and may be utilized to execute any aspects of the software components presented herein.

The computer architecture shown in FIG. 1 includes a central processing unit 102 (“CPU”), a system memory 108, including a random access memory 114 (“RAM”) and a read-only memory (“ROM”) 116, and a system bus 104 that couples the memory to the CPU 102. A basic input/output system containing the basic routines that help to transfer information between elements within the computer 100, such as during startup, is stored in the ROM 116. The computer 100 further includes a mass storage device 110 for storing an operating system 118, application programs, and other program modules, which are described in greater detail herein.

The mass storage device 110 is connected to the CPU 102 through a mass storage controller (not shown) connected to the bus 104. The mass storage device 110 and its associated computer-readable media provide non-volatile storage for the computer 100. Although the description of computer-readable media contained herein refers to a mass storage device, such as a hard disk or CD-ROM drive, it should be appreciated by those skilled in the art that computer-readable media can be any available computer storage media that can be accessed by the computer 100.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 100.

According to various embodiments, the computer 100 may operate in a networked environment using logical connections to remote computers through a network such as the network 120. The computer 100 may connect to the network 120 through a network interface unit 106 connected to the bus 104. It should be appreciated that the network interface unit 106 may also be utilized to connect to other types of networks and remote computer systems. The computer 100 may also include an input/output controller 112 for receiving and processing input from a number of other devices, including user input devices like a keyboard, mouse, or electronic stylus (not shown in FIG. 1). Similarly, an input/output controller may provide output to a display screen, a printer, or other type of output device (also not shown in FIG. 1).

As mentioned briefly above, a number of program modules and data files may be stored in the mass storage device 110 and RAM 114 of the computer 100, including an operating system 118 suitable for controlling the operation of a networked desktop, laptop, or server computer. The mass storage device 110 and RAM 114 may also store one or more program modules. In particular, the mass storage device 110 and the RAM 114 may store the project management application 122, which provides the functionality presented herein for showing and correcting irregularities in a schedule. In this regard, the project management application 122 may be utilized to create and manage a schedule 124. The mass storage device 110 and the RAM 114 may also store other types of program modules.

As described briefly above, the project management application 122 provides functionality for creating and managing a schedule 124. In this regard, the project management application 122 provides functionality for creating and managing tasks 126 within the schedule 124. A task is an activity that must be completed within a defined period of time. Tasks may be defined by a start date, end date, and duration. Tasks may also be dependent upon other tasks and resource assignments. The project management application 122 also provides functionality for creating and managing the allocation of resources 128. Resources are items required to carry out the tasks 126. For instance, resources may include people, equipment, funding, and facilities.

According to embodiments, the project management application 122 comprises the PROJECT project management application from MICROSOFT CORPORATION of Redmond, Wash. It should be appreciated, however, that the embodiments presented herein may be utilized with project management application programs from other vendors, including but not limited to PRIMAVERA P6 from PRIMAVERA SYSTEMS, INC., OMNIPLAN from OMNI DEVELOPMENT, INC., and ARTEMIS from ARTEMIS INTERNATIONAL SOLUTIONS CORPORATION. The embodiments illustrated herein are also described as executing as a client application on the computer 100. It should be appreciated, however, that the embodiments presented herein may also be implemented using a client-server model, such as for instance as a part of a World Wide Web (“Web”) site configured for providing project management functionality. Such a Web site may be made accessible over the public Internet or through a private Intranet.

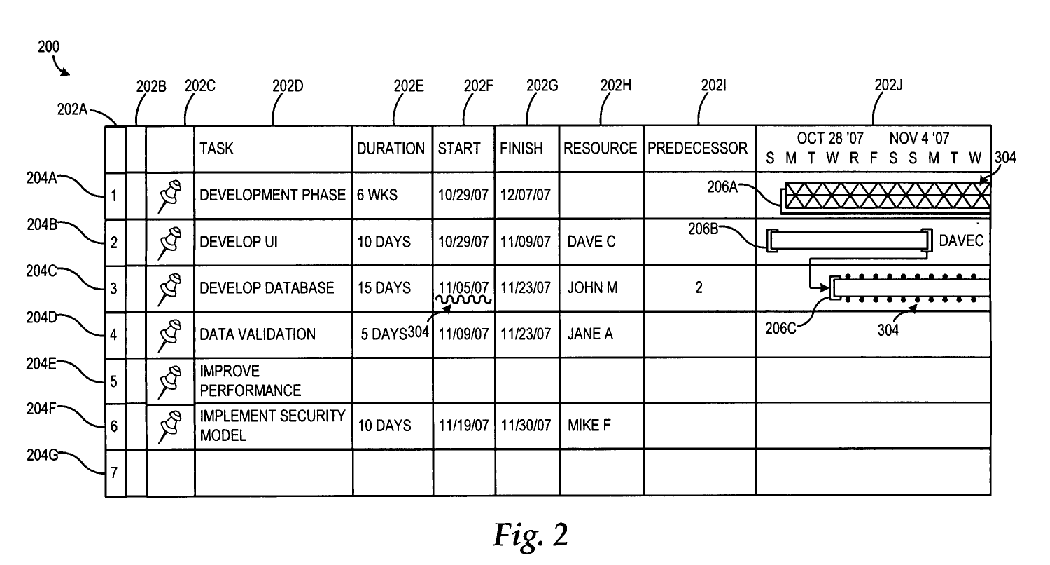

In order to visually display the schedule 124, the project management application 122 is also configured to display a Gantt chart for the schedule 124. A Gantt chart is a bar chart utilized to depict the tasks and resources within a project schedule. Bars within a Gantt chart are referred to herein as Gantt bars. A Gantt bar is a visual element within a Gantt chart that is utilized to depict the duration of a task or utilization of a resource within a project schedule. One example of a Gantt chart produced by the project management application 122 is shown in FIG. 2 and described below.

According to one embodiment, the project management application 122 provides functionality for automatically scheduling the tasks 126 and the allocation of the resources 128. Using this functionality, for instance, a project manager can enter information for a task 126, such as the duration of the task 126, resource assignments, and dependencies upon other tasks. The project management application 122 will then calculate start and finish dates for the task 126 using the provided information, thereby greatly simplifying the project planning process.

According to other aspects, the project management application 122 also provides functionality for allowing a user to manually schedule the tasks 126 and allocation of resources 128 within a schedule 124. For instance, using manual scheduling a project manager can manually define a task by providing the start date and the finish date or duration for any task 126 in the schedule 124. The project management application 122 will accept any valid user-provided value when manually scheduling tasks, thereby providing the user with a greater level of control over their data than available when automatic scheduling is utilized.

In order to assist a user with manual scheduling, the project management application 122 is configured in one embodiment to determine in the background whether a manually scheduled task will cause an irregularity in the schedule 124. An irregularity may be caused by the inclusion of task dates that realistically need to be delayed, tasks that include dates that need to be modified due to dependencies upon other tasks, or resources that are committed beyond their maximum capacity. Conversely, a user may not realize that some tasks may be started earlier to thereby optimize the schedule 124. It should be appreciated that manually defined tasks may also create other types of irregularities in the schedule 124.

As will be described in greater detail below, the project management application 122 is configured in one embodiment to provide a visual indication when an irregularity caused by a manually defined task is identified in a schedule 124. For instance, when an irregularity in a schedule 124 is identified, a visual attribute may be set for a visual element associated with the task 126 that causes the irregularity. For instance, a visual element may be set on a date associated with the manually defined task, an identifier for a resource associated with the manually defined task, or a Gantt bar associated with a manually defined task to thereby indicate the irregularity. An icon or other type of graphical element may also be displayed to indicate that an irregularity is present in the schedule.

As will be described in greater detail below, the visual element indicating the irregularity may be selected using an appropriate user input device. In response to such a selection, options may be displayed for addressing the irregularity indicated by the visual element. If one of the options is selected, the selected option will be performed for addressing the irregularity. According to embodiments, one of the options provides functionality for automatically scheduling the manually defined task that includes the irregularity. In other embodiments, an option is displayed that provides functionality for removing the visual indication of the irregularity thereby allowing a user to ignore the irregularity.

According to other embodiments, one of the options includes functionality for displaying recommendations for correcting the irregularity. The displayed recommendations for correcting the irregularity may include a recommendation for modifying a date associated with the manually defined task and leaving the manually defined task in a manual scheduling mode, a recommendation for modifying a date associated with the manually defined task and changing the manually defined task to an automatic scheduling mode, and a recommendation for ignoring the irregularity in the schedule caused by the manually defined task by removing the visual indications. Illustrative user interfaces provided by the project management application 122 for providing an indication of an irregularity in a schedule 124 and for addressing the irregularity are provided below with respect to FIGS. 2-5.

Turning now to FIG. 2, details regarding an illustrative user interface 200 provided by the project management application 122 will be described. The user interface 200 is provided by the project management application 122 in order to summarize the tasks 126 defined within a schedule 124. As shown in FIG. 2, the user interface 200 includes several columns 202A-202J and rows 204A-204G. The rows 204A-204G correspond to tasks 126 within a schedule 124. For instance, the row 204B corresponds to a task entitled “Develop UI”, which is to start on Oct. 29, 2007 and finish on Nov. 9, 2007. The row 204A, for instance, corresponds to a summary task that summarizes the duration and other information for other tasks.

The columns 202A-202J are utilized to provide information for each of the tasks represented by the rows 204A-204G. For instance, the column 202D is utilized to provide a name for each task, the column 202E is utilized to indicate the duration of each task, the column 202F is utilized to indicate the starting date for each task, the column 202G is utilized to indicate the completion date for each task, the column 202H is utilized to indicate a resource utilized by the task, the column 202I is utilized to indicate a dependent predecessor task, and the column 202J is utilized to display a Gantt bar that provides a visual representation of the duration of a task. It should be appreciated that the columns 202A-202J are merely illustrative and that other additional information regarding the tasks represented by the rows 204A-204G may be displayed.

As described briefly above, the project management application 122 provides functionality in one embodiment for permitting a user to manually schedule a task 126. As also described above, the project management application 122 is configured to determine whether a manually scheduled task will cause an irregularity within the schedule 124. In such a case, the project management application 122 is configured to provide a visual indication of the irregularity within the user interface 200. For instance, in the example shown in FIG. 2, the task 126 shown in the row 204C has been manually scheduled and an irregularity has been detected within the task. In particular, a start date has been specified in the column 202F that is earlier than the finish date of a predecessor task.

As a result of detecting the irregularity, the project management application 122 has provided a visual indication 304 on the date shown within the column 202F, thereby indicating the irregularity. In this example, the visual indication 304 comprises a stylistic underlining of the date shown in the column 202F. It should be appreciated, however, that the project management application 122 may set any visual attribute for a visual element associated with the manually defined task that causes the irregularity. For instance, the project management application 122 may utilize font properties, such as bold, underline, coloring, or others, to indicate that a manually scheduled task causes an irregularity in the schedule 124.

The project management application 122 may also display graphical elements to indicate an irregularity. For instance, as shown in FIG. 2, the Gantt bar 206C has been displayed with a visual indication 304 indicating that the corresponding task causes an irregularity within the schedule. Additionally, the Gantt bar 206A corresponding to a summary task has also been displayed with a visual indication 304 that indicates an irregularity within the schedule 124. A summary task summarizes one or more subtasks and may be displayed in a manner that distinguishes it from other tasks. For instance, a summary task may have bolded text, different Gantt bar styles, and subtasks of the summary task may be indented. In order to indicate an irregularity with a summary task, an additional visual indication may be applied thereto as shown in FIG. 2.

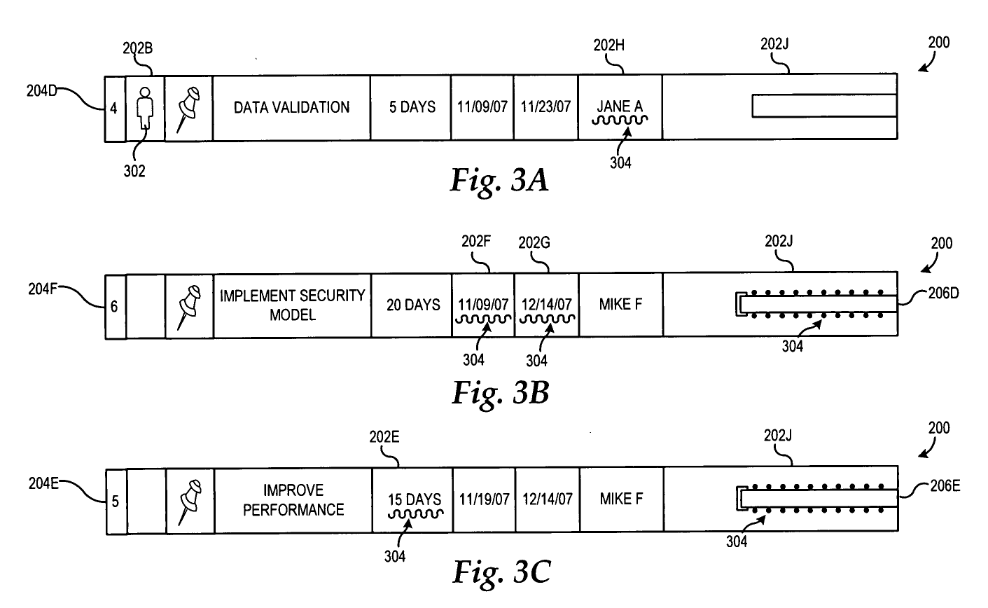

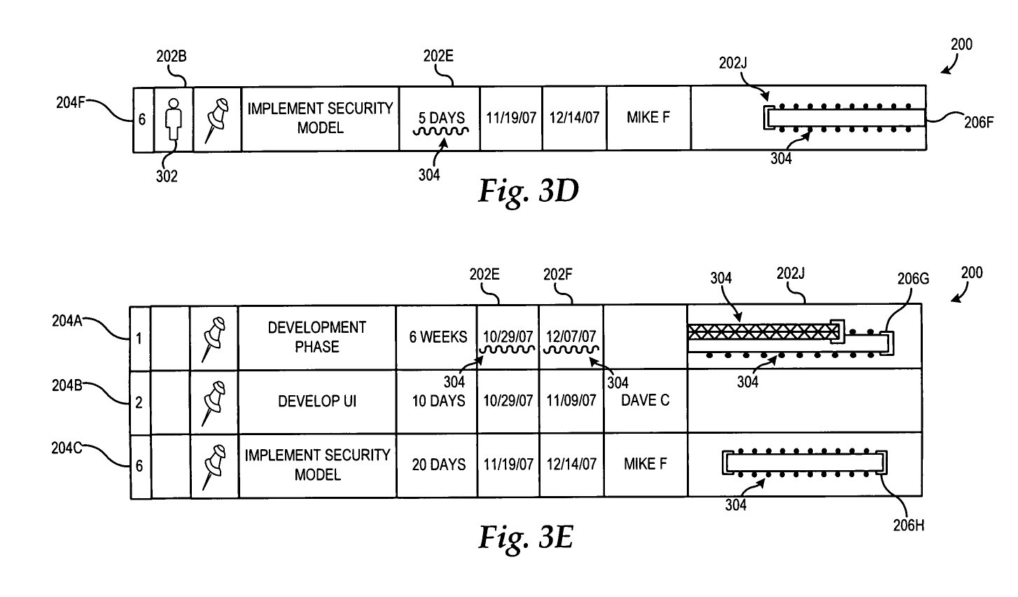

It should be appreciate that the Gantt bars 206A-206C may be modified with virtually any type of visual attribute to indicate the irregularity in the schedule 124 caused by a manually defined task. Additional examples of the types of visual indications that may be provided by the project management application 122 to indicate an irregularity in the schedule 124 will be described below with reference to FIGS. 3A-3E.

Referring now to FIGS. 3A-3E, additional details will be provided regarding the visual indications that may be provided by the project management application 122 to indicate an irregularity in the schedule 124 caused by a manually defined task 126. In particular, FIG. 3A shows a visual indication 304 displayed in conjunction with an identifier for a resource associated with a manually defined task. In this example, the resource referred to by the identifier “Jane A” has been overscheduled, thereby creating an irregularity within the schedule 124. As a result, the project management application 122 has displayed the visual indication 304 in conjunction with the identifier for the resource. Additionally, the project management application 122 has displayed a visual indication 302 in the form of an icon in the column 202B. The visual indication 302 also indicates an irregularity with the scheduled resource.

In the example shown in FIG. 3B, the project management application 122 has displayed visual indications in the columns 202F-202G indicating irregularities with dates corresponding to a manually defined task. In this example, the project management application 122 has detected an irregularity with the duration of the manually defined task. As a result, the project management application 122 has displayed the visual indications 304 in the columns 202F-202G. Additionally, the project management application 122 has displayed a visual indication 304 on the Gantt bar 206D for the corresponding task.

The example shown in FIG. 3C shows a similar irregularity where the duration specified in the column 202E is inconsistent with the specified start and finish dates. As a result, the visual indication 304 as been displayed in the column 202E and in conjunction with the display of the Gantt bar 206E.

A similar example is shown FIG. 3D but that also includes the over allocation of a resource. In the example shown in FIG. 3D, therefore, a visual indication 302 in the form of an icon has also been displayed. A visual indication 304 has been displayed in the column 202E and in conjunction with the display of the Gantt bar 206F.

FIG. 3E displays how a visual indication 304 may also be provided with respect to a summary task. A summary task summarizes one or more child tasks. Summary tasks can be flagged with an irregularity when there is an irregularity with the summary task, such as finishing later than their child tasks, or if there are irregularities with one of the child tasks. For example, in FIG. 3E, the task specified by the row 204C has been determined to include an irregularity. As a result, the visual indication 304 is displayed in conjunction with the display of the Gantt bar 206H. The summary task specified by the row 204A also includes several visual indications 304 indicating that the manually defined child task specified by the row 204C implies that that the summary task is inconsistent. In this example the finish date of the task specified by the row 204C is later than the finish date of the summary task specified by the row 204A. Visual indications 304 are therefore provided in the columns 202E and 202F, and in conjunction with the Gantt bar 206G corresponding to the summary task.

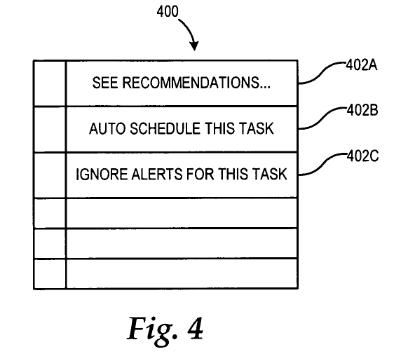

Turning now to FIG. 4, additional details will be described regarding the functionality provided by the project management application 122 for collecting or otherwise addressing an irregularity in the schedule 124 caused by a manually defined task 126. In particular, as discussed briefly above, a visual element displayed by the project management application 122 with a visual indication indicating an irregularity in the schedule 124 may be selected by a user using an appropriate user input device. For instance, according to one implementation, a user may utilize a mouse user input device to select a visual element associated with a manually defined task that has been displayed with a visual indication indicating an irregularity in the schedule. In response to such a selection, the project management application is operative in one embodiment to display the user interface 400 shown in FIG. 4. The user interface 400 includes several selectable options 402A-402C for addressing the irregularity in the schedule 124. One of the selected options 402A-402C may be selected by the user utilizing the user input device. In response to receiving such a selection, the selected option is performed for correcting or otherwise addressing the irregularity in the schedule 124.

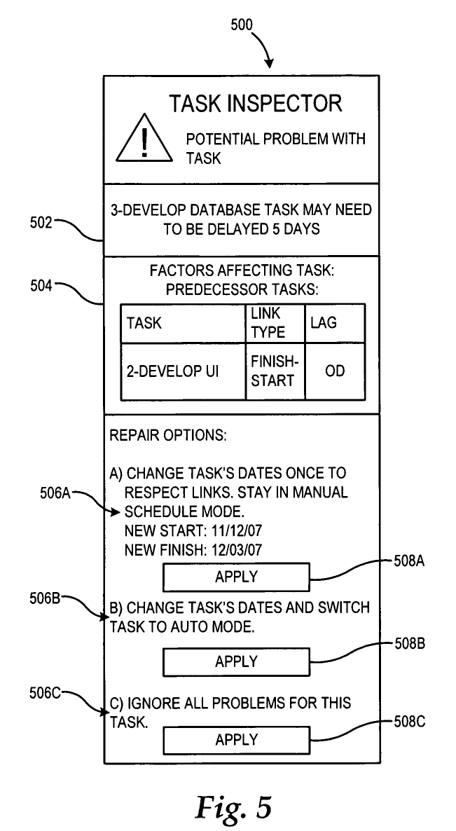

In one implementation, the selectable option 402A corresponds to an option for viewing several recommendations for addressing the irregularity in the schedule. Selection of the selectable option 402A will cause the user interface 500 to be displayed. The user interface 500 includes multiple recommendations for addressing the irregularity in the schedule 124 and is described in greater detail below with respect to FIG. 5.

According to another embodiment, the selectable option 402B corresponds to an option for automatically scheduling the task 126 that includes the irregularity. If a user selects the selectable option 402B, the project management application 122 performs an automated scheduling routine to reschedule the manually defined task 126 in an attempt to remove the irregularity with the task 126. In this manner, selection of the selectable option 402B allows the user to have the manually scheduled task 126 automatically scheduled by the project management application 122.

According to other aspects, the selectable option 402C corresponds to an option for ignoring the visual indication provided by the project management application 122 that indicates an irregularity for the task. If the selectable option 402C is selected, any visual indications 304 provided by the project management application 122 for the corresponding task will be removed from the user interface 200. In this manner, a user can cause the project management application 122 to suppress all visual indications of an irregularity in the schedule caused by a manually defined task. It should be appreciated that the user interface 400 may include other selectable options for addressing or correcting the irregularity caused in the schedule 124 by the manually defined task 126.

Referring now to FIG. 5, additional details will be provided regarding the user interface 500. As discussed briefly above, the user interface 500 is displayed by the project management application 122 in response to the selection of the selectable option 402A. As shown in FIG. 5, the user interface 500 includes a message 502 indicating the irregularity caused by the corresponding task 126. The user interface 500 also includes a message 504 identifying any factors that may be responsible for causing the irregularity in the schedule 124. In the example shown in FIG. 5, a delay in the completion of a predecessor task may be responsible for the irregularity in the schedule 124.

As also discussed above, the user interface 500 provides one or more recommendations for correcting or otherwise addressing the irregularity in the schedule 124. For instance, in one implementation the user interface 500 includes a recommendation 506A for modifying one or more dates associated with the task to correct the irregularity, but which leaves the manually defined task in a manual scheduling mode of operation. In this manner, the project management application 122 can correct the irregularity in the schedule 124 caused by the task 126, but still allow a user to retain control over the manual scheduling of the task. Selection of the user interface control 508A will cause this recommendation to be selected and performed by the project management application 122.

The user interface 500 may also include a recommendation 506B for modifying dates associated with the manually defined task to correct the irregularity in the schedule 124 but which changes the manually defined task to an automatic scheduling mode provided by the project management application 122. In this manner, the corresponding task will be automatically scheduled by the project management application 122 as necessary. Selection of the user interface control 508B will cause the recommendation 506B to be selected and performed by the project management application 122.

The user interface 500 may also include a recommendation 506C for ignoring the irregularity in the schedule 124 caused by the manually defined task 126. As discussed above, the recommendation 506C will cause the project management application 122 to remove the visual indications 302 and 304 from the user interface 200. In this manner, a user will not be notified of the irregularity in the schedule caused by the manually defined task 126 even though the irregularity still exists. Selection of the user interface control 508C with an appropriate user input device will cause the recommendation 506C to be selected and applied by the project management application 122. It should be appreciated that the recommendations 506A-506C are merely illustrative and that the user interface 500 may provide other types of recommendations for addressing or otherwise correcting the irregularity caused in the schedule 124 by the task 126.

It should be appreciated that, in other embodiments, additional recommendations may be provided for correcting the irregularity in the schedule. For instance, in the case of over allocated resources, recommendations may be provided for assigning the work referenced by the task to another resources, leveling the resource referenced by the task, or spreading the work referenced by the task over a longer period of time so that the resource is not over allocated. Other types of recommendations may also be provided.

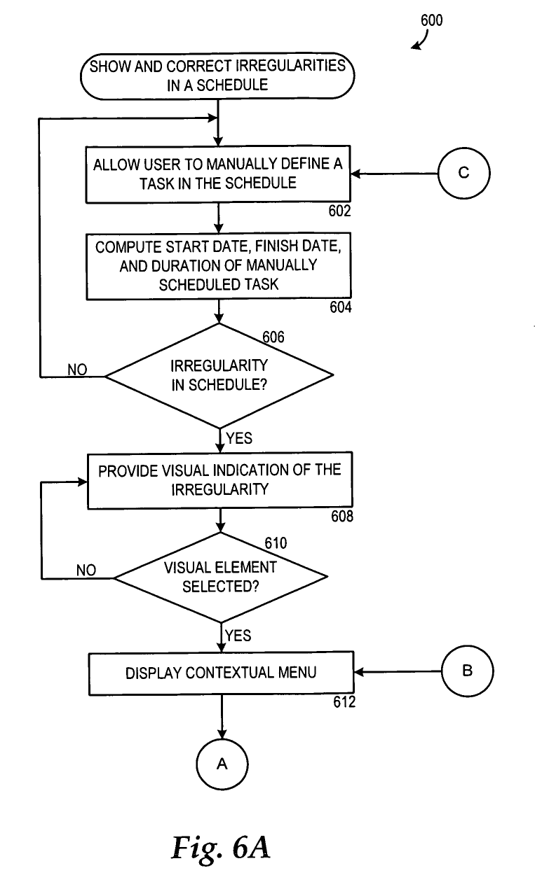

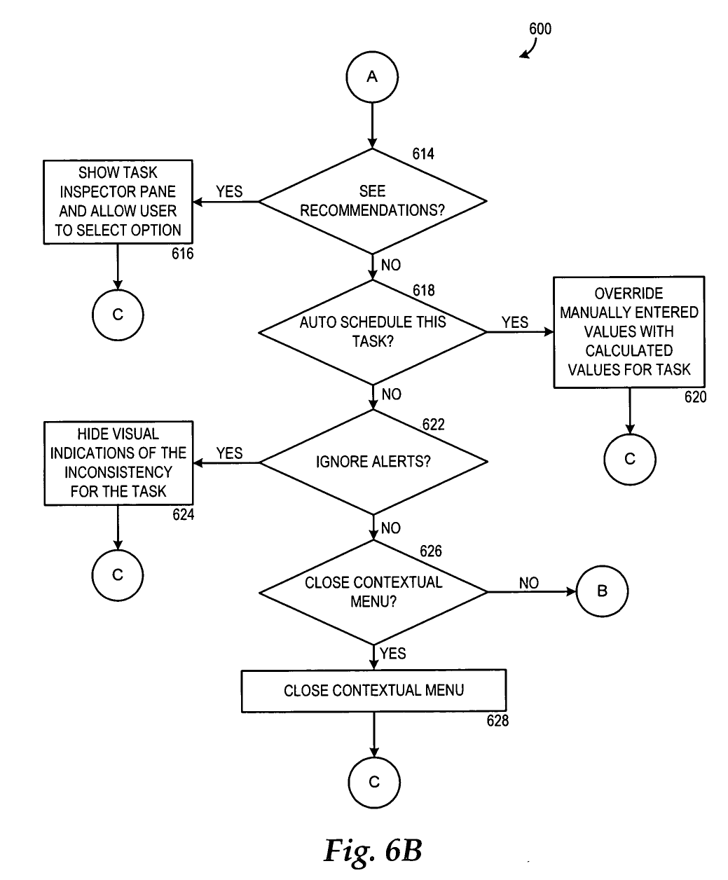

Turning now to FIGS. 6A-6B, additional details will be provided regarding the embodiments presented herein for showing and correcting irregularities in a schedule. In particular, FIGS. 6A-6B are flow diagrams showing a routine 600 that illustrates aspects of the operation of the project management application 122 for showing and correcting irregularities in a schedule in one embodiment presented herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 600 begins at operation 602, where the project management application 122 provides functionality for allowing a user to manually define a task 126 in the schedule 124. Once a task 126 has been manually defined, the routine 600 continues to operation 604 where the project management application 122 performs background processing to determine whether the manually scheduled task 126 creates an irregularity in the schedule 124. For instance, the project management application 122 may compute the start date, finish date, and duration of the manually scheduled task 126. Following this processing, the routine 600 proceeds to operation 604, where the project management application 122 determines whether the manually scheduled task 126 generates an irregularity in the schedule 124. If not, the routine 600 returns to the operation 602 described above. If an irregularity is generated, the routine 600 proceeds from operation 606 to operation 608.

At operation 608, the project management application 122 displays the visual indications 302-304 discussed above that indicate the irregularity within the schedule 124. The routine 600 then proceeds to operation 610 where the project management application 122 determines whether a user has selected a visual element that includes a visual indication indicating an irregularity in the schedule 124. If a visual element has not been selected, the routine 600 returns to operation 608, described above. If a user has selected a visual element, the routine 600 proceeds to operation 612, where the user interface 400 described above with respect to FIG. 4 is displayed. From operation 612, the routine 600 then proceeds to operation 614.

At operation 614, the project management application 122 determines whether the user has selected the selectable option 402A for correcting or otherwise addressing the irregularity in the schedule 124. If so, the routine 600 proceeds from operation 614 to operation 616 where the user interface 500 shown in FIG. 5 is displayed to a user and wherein the user is permitted to select one of the recommendations 506A-506C for addressing the irregularity. From operation 616, the routine 600 returns to operation 602, described above.

If, at operation 614, the project management application 122 determines that the user has not selected the selectable option 402A, the routine 600 proceeds to operation 618. At operation 618, the project management application 122 determines whether a user has selected the selectable option 402B for automatically scheduling the task 126. If so, the routine 600 proceeds from operation 618 to operation 620, where the manually entered values are replaced with values calculated by the project management application 122 for the task 126. The routine 600 then proceeds from operation 620 to operation 602, described above.

If, at operation 618, the project management application 122 determines that the user has not selected the selectable option 402B for automatically scheduling the task 126, the routine 600 proceeds to operation 622. At operation 622, the project management application 122 determines whether the user has selected the selectable option 402C for ignoring the visual indications 302-304 provided for the task 126. If so, the routine 600 proceeds to operation 624 where the visual indications 302-304 are removed from the user interface 200 for the corresponding task. The routine 600 then proceeds from operation 624 to operation 602, described above.

If, at operation 622 the project management application 122 determines that the user has not selected the selectable option 402C for ignoring alerts for the task 126, the routine 600 continues to operation 626. At operation 626, the project management application 122 determines whether the user has requested to close the user interface 400. For instance, a user may provide a selection outside of the user interface 400 to provide such an indication. If the user has not requested that the user interface 400 be closed, the routine 600 proceeds from operation 626 to operation 612, described above. If, however, the user has requested to close the user interface 400, the routine 600 proceeds to operation 628 where the user interface 400 is removed. The routine 600 then proceeds from operation 628 to operation 602, described above where the above process is repeated.

Based on the foregoing, it should be appreciated that technologies for showing and correcting irregularities in a schedule are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for showing and correcting an irregularity in a schedule, the method comprising:
determining whether a manually defined task in the schedule causes an irregularity in the schedule; and
in response to determining that the manually defined task causes an irregularity in the schedule, providing a visual indication of the irregularity.

2. The method of claim 1, wherein providing a visual indication of the irregularity comprises setting a visual attribute for indicating the irregularity on a visual element associated with the manually defined task.

3. The method of claim 2, wherein the visual element associated with the manually defined task comprises a date.

4. The method of claim 2, wherein the visual element comprises a Gantt bar.

5. The method of claim 2, wherein the visual element comprises an identifier for a resource associated with the manually defined task.

6. The method of claim 5, further comprising displaying an icon for indicating the irregularity.

7. The method of claim 2, further comprising:
receiving a selection of the visual element;
in response to the selection of the visual element, displaying one or more selectable options for addressing the irregularity;
receiving a selection of one of the options; and
performing the selected one of the options for addressing the irregularity.

8. The method of claim 7, wherein a first of the options comprises an option for providing one or more recommendations for correcting the irregularity, and wherein the method further comprises displaying the one or more recommendations in response to receiving a selection of the first of the options.

9. The method of claim 8, wherein the one or more recommendations comprise a recommendation for modifying one or more dates associated with the manually defined task and leaving the manually defined task in a manual scheduling mode.

10. The method of claim 8, wherein the one or more recommendations comprise a recommendation for modifying one or more dates associated with the manually defined task and changing the manually defined task to an automatic scheduling mode.

11. The method of claim 8, wherein the one or more recommendations comprise a recommendation for ignoring the irregularity in the schedule caused by the manually defined task.

12. The method of claim 8, wherein a second of the options comprises an option for automatically scheduling the manually defined task, and wherein the method further comprises performing an automated scheduling for the manually defined task in response to receiving a selection of the second of the options.

13. The method of claim 9, wherein a third of the options comprises an option for ignoring the visual indication of the irregularity, and wherein the method further comprises removing the visual indication of the irregularity in response to receiving a selection of the third of the options.

14. A computer storage medium having computer executable instructions stored thereon which, when executed by a computer, cause the computer to:
receive a manually defined task for inclusion in a schedule;
determine whether the manually defined task creates an irregularity in the schedule;
in response to determining that the manually defined task creates an irregularity in the schedule, to set a visual attribute for indicating the irregularity on a visual element associated with the manually defined task;
receive a selection of the visual element;
in response to receiving the selection of the visual element, to display one or more selectable options for addressing the irregularity;
receive a selection of one of the selectable options; and to perform the selected one of the selectable options to address the irregularity.

15. The computer storage medium of claim 14, wherein the visual element comprises one or more of a date, a Gantt bar, or an identifier for a resource associated with the manually defined task.

16. The computer storage medium of claim 15, wherein one of the selectable options corresponds to an option for providing one or more recommendations for correcting the irregularity.

17. The computer storage medium of claim 14, wherein one of the selectable options corresponds to an option for automatically scheduling the manually defined task.

18. The computer storage medium of claim 14, wherein one of the selectable options corresponds to an option for disabling the setting of the visual attribute for indicating the irregularity.

19. A method for showing and correcting an irregularity in a schedule, the method comprising:
determining whether a manually defined task in the schedule causes an irregularity in the schedule;
in response to determining that the manually defined task causes an irregularity in the schedule, setting a visual attribute for indicating the irregularity on a visual element associated with the manually defined task;
receiving a selection of the visual element;
in response to the selection of the visual element, displaying one or more selectable options for addressing the irregularity;
receiving a selection of one of the selectable options; and
performing the selected one of the selectable options for addressing the irregularity, wherein the selectable options comprise a first option for providing one or more recommendations for correcting the irregularity, a second option for automatically scheduling the manually defined task, and a third option for ignoring the visual indication of the irregularity.

20. The method of claim 19, wherein the visual element comprises one or more of a date, a Gantt bar, or an identifier for a resource associated with the manually defined task.
